(19) United States
(12) Patent Application Publication
(10) Pub. No.: US 2010/0092142 A1
(43) Pub. Date: Apr. 15, 2010

(54) Hermetic optical connection

(76) Inventors: Thomas J. Walsh, III, Aubum, NY (US); Scott A. Raszka, Woodstock, CT (US)

Correspondence Address: LOUIS J FRANCO;LAW OFFICE OF LOUIS J FRANCO, 250 ARBOR, LUNENBURG, MA, 01462, US

(21) Appl. No.: 12/583,762

(22) Filed: Aug. 25, 2009

Related U.S. Application Data
(60) Provisional application No. 61/190,423, filed on Aug. 28, 2008.

(51) Int. Cl. G02B 6/02; G02B 6/00

(52) U.S. Cl. 385/123; 385/138

(57) ABSTRACT

A light-transmission assembly includes a hermetic optical connection having a housing with a housing side wall extending between opposed first and second housing ends. The housing is configured for sealable securement within a bulkhead bore through a bulkhead separating regions of relatively low and high fluid pressure and includes an interior surface defining a housing bore that extends between and through the first and second housing ends. Sealably bonded within the housing bore is a light-transmissive, rigid optical component having opposed first and second optical-component faces and an optical-component side wall extending between the optical-component faces. The assembly further includes at least a first flexible light conduit having opposed first and second light-conduit faces through which light can enter and exit the first flexible light conduit. The first light-conduit face of the first light conduit is retained in optical alignment with the first optical-component face.

### PROVISIONAL PRIORITY CLAIM

Priority based on Provisional Application, Ser. No. 61/190,423 filed Aug. 28, 2008, and entitled “HERMETIC OPTICAL CONNECTION” is claimed. The entirety of the disclosure of the previous provisional application, including the drawings, is incorporated herein by reference as if set forth fully in the present application.

### BACKGROUND

Flexible optical elements such as single optical fibers and elongated, non-coherent optical fiber bundles are widely used to transmit light signals between first and second locations. Flexible optical fiber bundles have been employed in fluid-level monitoring systems, including systems in which fluid is subjected to very high pressures such as, by way of example, hydraulic braking systems in aircraft and other vehicles. In such systems, a fluid is retained within an enclosure or chamber defined by at least one chamber wall that separates an external environment at atmospheric, or otherwise relatively low pressure, from an interior high-pressure region in which pressures greatly exceeding those of the external environment are produced.

In order to monitor fluid levels, first and second optical fiber conduits are sealably routed through a bore in a chamber wall in order to facilitate light-signal communication between the interior and exterior of the chamber. Illustratively, the first conduit is a light-input conduit through which light emitted from a light source external to the chamber, and fed into a light-acceptance end of the first conduit, is transmitted for emission through a light-output end retained at a predetermined location inside the fluid chamber. The second conduit includes a light-collection end located inside the fluid chamber and optically aligned with the light-output end of the first conduit. Light emitted through the light-output end of the first conduit is collected through the light-collection end of the second conduit and transmitted through the second conduit to a light-emission end of the second conduit. Light emitted from the light-emission end is detected by a light detector optically aligned with the light-emission end.

The predetermined location at which the light-output end is retained corresponds to a predetermined fluid level within the chamber. More specifically, when the fluid level within the chamber is below the light-output and light-collection ends of, respectively, the first and second conduits, light emitted from the light-output end of the first conduit is readily collected by the light-collection end of the second conduit and transmitted for detection by the light-detector. If, however, at least one of the light-output and light-collection ends is immersed in the fluid whose level is being monitored, light transmission to the detector is at least diminished, if not entirely obstructed by the presence of fluid between the light-output and light-collection ends. The detector is configured to produce a predetermined output signal at least when light transmission is unobstructed by fluid, thereby indicating a “low fluid level.” In some alternative fluid-level monitoring systems, the light-output end of the first conduit is selectively “optically linked” to the light-collection end of the second conduit through an optically refractive element such as a prism, by way of non-limiting example. The level of the refractive element within the fluid chamber corresponds with a desired fluid level such that, when the fluid whose level is to be detected is not sufficiently high to contact the refractive element, light emitted from the light-output end of the first conduit enters the prism and is reflective off of at least one surface therein and into the light-collection end of the second conduit. However, when the refractive element (e.g., prism) is at least partially immersed in the fluid whose level is to be monitored, the ratio of the refractive indices of the refractive element and the fluid is such that the light is transmitted through the prism and into the fluid, thereby resulting in an interruption in light collection by the light-collection end of the second conduit, and an attendant signal at the detector.

Previous fluid-level monitoring systems employing optical barriers and/or refractive elements such as those described above have employed continuous optical conduits encased in mechanical sheathing fabricated from materials such as plastic and, more particularly, Polymethyl-Methacrylate (PPMA). Among other drawbacks, failures in the bond between the optical fiber(s) and the outer sheathing, and between the outer surfaces of continuous conduits and the portion of the chamber wall defining the bore through which they are fed, have compromised the hermeticity of the optical link, resulting in leaks of fluid to the exterior of the chamber.

Accordingly, a need exists for a more reliable hermetic optical connection through a bulkhead separating regions of relatively high and low fluid pressure.

### SUMMARY

In accordance with a first illustrative set of embodiments, a partially flexible light-transmission assembly includes a hermetic optical connection for use through a bulkhead separating a first region of relatively low fluid pressure from a second region of relatively high fluid pressure. For instance, selected embodiments are configured for forming a fluid-tight optical passage through a bulkhead defining an enclosure containing high-pressure hydraulic fluid situated in an environment within typical atmospheric air-pressure ranges. An illustrative hermetic optical connection includes a housing configured for sealable disposition within a bulkhead bore extending between the regions of relatively low and high fluid pressure. The housing has opposed first and second housing ends and at least one housing side wall extending between the first and second housing ends. The at least one housing side wall includes an exterior surface and an interior surface defining a housing bore that extends between and through the first end second ends of the housing. In various versions, the housing is made from a non-glass material such as metal or ceramic, by way of non-limiting example.

In each of various versions, the hermetic optical connection further includes a light-transmissive, rigid optical component having a first optical-component end with a first optical-component face and a second optical-component end, opposite the first optical-component end, with a second optical-component face opposite the first optical-component face. Additionally, an optical-component side wall extends between the optical-component faces. In a typical version, the rigid optical component is elongated between the optical-component faces such that the faces are longitudinally opposed. In some versions, the rigid optical component includes a core exhibiting a first refractive index and a cladding disposed about the core and exhibiting a second refractive index, lower in magnitude than the first refractive index, such that light entering either of the first and second faces can propagate by internal reflection between the opposed optical-component faces and exit the face opposite the face through which it entered. In alternative versions, the rigid optical component is an unclad mass of light-transmissive material. Additionally, while, in a typical version the rigid optical component is defined by a single, cylindrical side wall, rigid optical components of alternative cross-sectional geometry are envisioned as within the scope of the invention as defined by the appended claims. Alternative cross-sectional geometries include, by way of non-limiting example, triangular, rectangular (including square), pentagonal, hexagonal and octagonal.

One illustrative light-transmissive assembly further includes a flexible light conduit having opposed first and second light-conduit ends and a light-conduit outer surface extending between the first and second light-conduit ends. In a typical version, the flexible light conduit is configured such that light entering one of the first and second light-conduit ends propagates through the light-conduit by internal reflection for emission through the other of the first and second light-conduit ends. Accordingly, the flexible light conduit includes at least one optical core having a core refractive index and a cladding having a cladding refractive index lower in magnitude than the core refractive index. Typically, the flexible light conduit comprises a single “macroscopic” optical fiber (e.g., on the order of a millimeter or more in diameter) fabricated from materials such as plastic. However, in alternative versions, the flexible light conduit could comprise a bundle of plural optical fibers adjacently arranged for the non-coherent transmission of illuminating light between the light-conduit ends.

In one illustrative embodiment, the rigid optical component is inserted at least partially within the housing such that at least one of the first and second optical-component faces, and at least a portion of the length of the optical-component side wall extending therefrom, is situated within the housing bore. Furthermore, one of the first and second light-conduit ends is inserted into the housing bore such that the inserted light-conduit end is optically aligned, within the bore, with one of the first and second optical-component faces. The optically aligned optical-component face and light-conduit end are retained within the housing bore in fixed positions relative to one another, and to the housing, at least in part by a bonding agent that extends along at least a portion of the optical-component side wall and, in some cases, a portion of the light-conduit outer surface. The bonding agent sufficiently surrounds the optical-component side wall to prevent the flow of fluid through the housing between the regions of relatively low and high pressure. The bonding agent can comprise any of various substances including, by way of non-limiting example, at least one of frit, fused glass, polymeric material and epoxy. When frit is employed, it may be applied in a paste-like state or may be incorporated into a rigid, sleeve-like preform that is subsequently heated to fuse about the optical-component side wall and to the interior surface of the housing. Moreover, in a typical version, the optically aligned optical-component face and light-conduit end are retained in mutual mechanical contact so as to maximize optical communication therebetween and, in various versions, structural integrity. However, in the absence of express claim limitations to the contrary, it is to be understood that versions in which the optically aligned optical-component face and light-conduit end are not in mutual physical contact are within the scope and contemplation of the invention as defined in the appended claims. In versions of the latter type, a light-transmissive bonding agent (e.g., optical epoxy) may be used to minimize interruption of light transmission between the optical-component face and light-conduit end.

In order to facilitate the disposition of liquefied and/or paste-like bonding agents between the interior surface of the housing and the peripheral optical-component side wall, the housing bore and rigid optical component of each of various alternative versions are configured, and relatively situated, such that a peripheral pocket or void surrounds the rigid optical component along at least a portion of the length of the optical-component side wall. In a version including a peripheral pocket disposed about a portion of the length of the rigid optical component, the housing side wall has defined therethrough at least one port leading from the peripheral pocket to the exterior of the housing through which, during fabrication of the light-transmission assembly, bonding agent in a liquefied or paste-like state is introduced to fill the pocket. In accordance with alternative fabrication techniques, the housing is retained in a vertical orientation, with the rigid optical component pre-centered therein, and bonding agent is introduced between the housing and rigid optical component and allowed to cure.

In some versions, each of the first and second optical-component faces is situated within the housing and optically aligned with a light-conduit end of a flexible light conduit. For instance, the first optical-component face is optically coupled with a light-conduit end of a first light conduit extending from the housing to one side of the bulkhead and the second optical-component face is optically coupled with a light-conduit end of a second light conduit extending from the housing to the side of the bulkhead opposite the side of the bulkhead to which the first light conduit extends.

Representative, non-limiting embodiments are more completely described and depicted in the following detailed description and the accompanying drawings.

### BRIEF DESCRIPTION OF THE DRAWINGS

FIG. 1 depicts an elongated, partially flexible light-transmission assembly including a hermetic optical connection passing through a bulkhead separating a first region of relatively low fluid pressure from a second region of relatively high fluid pressure; and

FIGS. 2A, 2B and 2C show sequential steps in the insertion and bonding of a bonding collar between the interior surface of a housing defining a bore and a rigid optical component in order to form a hermetic optical connection.

### DETAILED DESCRIPTION

The following description of various embodiments of a hermetic optical connection is illustrative in nature and is therefore not intended to limit the scope of the invention or its application of uses. Among the various illustrative versions depicted in the drawings, like reference characters correspond to similar or analogous components.

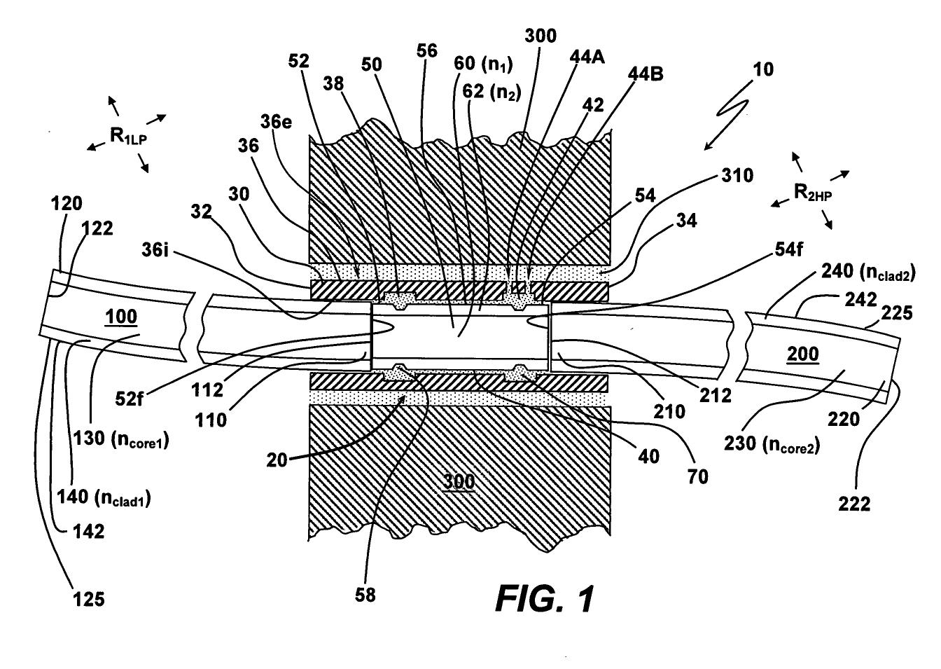

Referring to FIG. 1, an illustrative light-transmission assembly 10 including a hermetic optical connection 20 is disposed within a bulkhead bore 310 extending through a bulkhead 300 that separates a first region R_{1LP} of relatively low fluid pressure from a second region R_{2HP} of relatively high fluid pressure. The hermetic optical connection 20 includes a housing 30 having opposed first and second housing ends 32 and 34 and at least one housing side wall 36 extending between the first and second housing ends 32 and 34. The at least one housing side wall 36 includes an exterior surface 36e and an interior surface 36i defining a housing bore 40 that extends between and through the first end second ends 32 and 34 of the housing 30. The particular manner by which the housing 30 is sealably secured within the bulkhead bore 310 is not of central relevance to the invention. However, illustrative examples of how the housing 30 could be secured within the bulkhead bore 310 include the use of one or more of (i) flowable bonding agent such as epoxy, (ii) welding, (iii) threaded fasteners, and (iv) compression fittings.

The hermetic optical connection 20 further includes a light-transmissive, rigid optical component 50 having a first optical-component end 52 with a first optical-component face 52f and a second optical-component end 54 with a second optical-component face 54f opposite the first optical-component face 52f. Additionally, an optical-component side wall 56 extends between the optical-component faces 52f and 54f. In the illustrative version of FIG. 1, the rigid optical component 50 includes a core 60 exhibiting a first refractive index n₁ and a cladding 62 disposed about the core 60 and exhibiting a second refractive index n₂, lower in magnitude than the first refractive index n₁, such that light entering either of the first and second faces 52f and 54f can propagate by internal reflection through the core 60 and exit the face 52f or 54f opposite the face 52f or 54f through which it entered. In the particular version depicted in FIG. 1, the optical component 50 is defined by a cylindrical side wall 56; however, as explained in the summary, rigid optical components 50 of alternative configurations are within the scope and contemplation of the invention.

Referring still to FIG. 1, the light-transmission assembly 10 further includes first and second flexible light conduits 100 and 200. The first light conduit 100 is situated in the first region R_{1LP} of relatively low fluid pressure and includes opposed first and second light-conduit ends 110 and 120 exhibiting, respectively, first and second light-conduit faces 112 and 122 through which light can alternatively enter and exit the first flexible light conduit 100. A first-conduit core 130 having a first-core refractive index n_{core1} extends between the first and second light-conduit ends 110 and 120. The first-conduit core 130 is encased in a first-conduit cladding 140 having a first-cladding refractive index n_{clad1} lower in magnitude than the first-core refractive index n_{core1} such that light entering either of the first and second light-conduit faces 112 and 122 is internally reflected through the light conduit 100 for emission through the opposite one of the first and second light-conduit faces 112 and 122. The first-conduit cladding 140 includes an outer surface 142 that, in the case of the illustrative version of FIG. 1, constitutes a light-conduit outer surface 125 extending between the first and second light-conduit ends 110 and 120 of the first light conduit 100. In alternative versions, the first-conduit cladding 140 is itself jacketed in a flexible protective casing (not shown) such that the light-conduit outer surface 125 and the outer surface 142 of the first-conduit cladding 140 are mutually distinct.

With continued reference to the illustrative embodiment of FIG. 1, the entirety of the rigid optical component 50 is situated within the housing bore 40 such that the first optical-component face 52f is recessed relative to the first housing end 32 and the second optical-component face 54f is recessed relative to the second housing end 34. The first flexible light conduit 100 extends through the first housing end 32 such that (i) the first light-conduit end 110 is within the housing bore 40, (ii) the first light-conduit face 112 is optically aligned with the first optical-component face 52f, and (iii) the second light-conduit end 120 is external to the housing 30. The optically aligned first optical-component face 52f and first light-conduit end 110 are retained within the housing bore 40 in fixed positions relative to one another and to the housing 30 and, as in the illustrative example of FIG. 1, may be retained in mutual mechanical contact.

At least a portion of the length of the optical-component side wall 56 is sufficiently surrounded by a bonding agent 70 to prevent the flow of fluid (not shown) through the housing bore 40 and the expulsion of the rigid optical component 50 from the housing bore 40 into the first region R_{1LP} of relatively low fluid pressure by highly pressurized fluid (not shown) in the second region R_{2HP}. Although, as described in the summary, the bonding agent 70 can be any of various substances introduced between the optical-component side wall 56 and the housing-wall interior surface 36i in order to mutually bond them, the bonding agent 70 shown in a “cured state” in FIG. 1 derived from a previously “flowable” substance (e.g., liquid, gel or paste) such as, by way of non-limiting example, a substance containing at least one of (i) epoxy, (ii) a polymeric material, (iii) frit and (iv) melted glass.

To the end of introducing a flowable bonding agent 70 peripherally about at least a portion of the optical-component side wall 56, the interior surface 36i of the housing side wall 36 and the optical-component side wall 56 are configured, and relatively situated, such that at least one peripheral pocket or void 42 surrounds the rigid optical component 50. In the version of FIG. 1, the housing side wall 36 has defined therethrough first and second ports 44A and 44B rendering each void 42 in fluid communication with the environment exterior to the housing 30. Although not essential to the introduction of flowable bonding agent 70, the inclusion of first and second ports 44A and 44B serves the purposes of (i) facilitating a detectable (e.g., visible) indication as to when the void 42 has been filled with bonding agent 70 and (ii) allowing gases (e.g., air) displaced from the void 42 by bonding agent 70 to escape, thereby reducing, and ideally, eliminating, gas bubbles from the void 42.

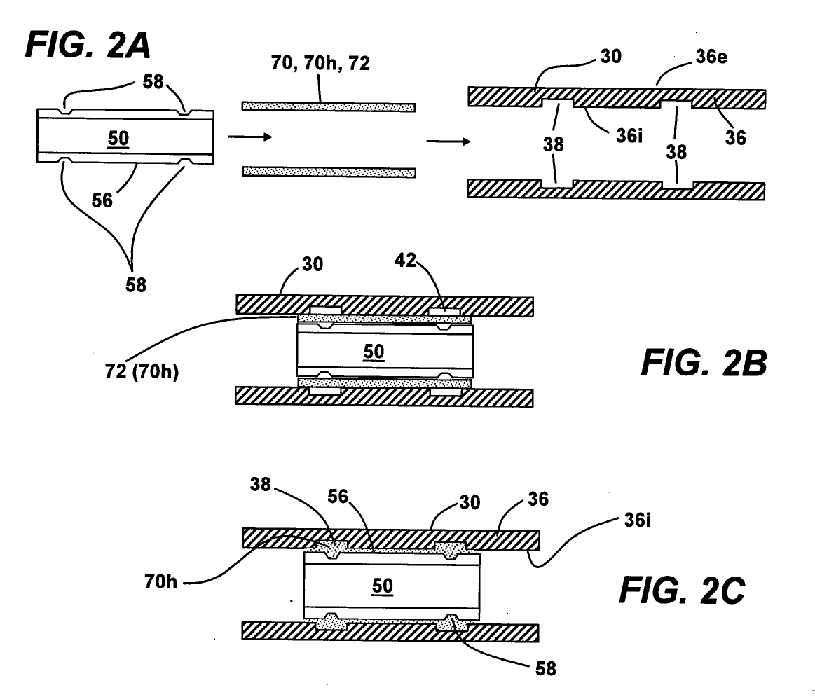

While in some versions of the hermetic optical connection 20, such as those described immediately above, a flowable bonding agent 70 is “flowably introduced” into at least one void 42 defined between the rigid optical component 50 and the housing 30 in order to mutually bond the same, an alternative method of securement is discussed with interlocutory reference to FIGS. 2A through 2C. With initial reference to FIGS. 2A and 2B, a bonding collar 72 is interposed between the side wall 56 a rigid optical component 50 and the housing-wall interior surface 36i of a housing 30. The bonding collar 72 is fabricated from a heat-activatable bonding agent 70h which, when adequately heated, softens and adheres to both the optical-component side wall 56 and the housing-wall interior surface 36i. The softened bonding agent 70h is then permitted to cool, thereby mutually bonding the housing 30 and the rigid optical component 50, as shown in FIG. 2C. Among the non-limiting illustrative materials from which the bonding collar 70 can be alternatively fabricated is glass, including a rigid formation of frit.

Regardless of the particular manner in which bonding agent 70 is introduced into at least one void 42 defined between the rigid optical component 50 and the housing 30, in various versions, at least one of (i) the housing 30 and (ii) the rigid optical component 50 is undulated in order to enhance the bond between the housing 30 and optical component 50. Illustratively, the interior surfaces 36i of the housings 30 shown in FIGS. 1 through 2C include interior undulations (e.g., “grooves” or “ridges”) 38, while the side walls 56 of the illustrative optical components 50 include exterior undulations 58 about their peripheries. It will be readily appreciated through inspection of the drawings that, when bonding agent 70 or 70h is in a “flowable state” within a void 42 defined between the rigid optical component 50 and the housing 30, the bonding agent 70 or 70h will flow into the undulations 38 and 58. Once cured, the disposition of bonding agent 70 or 70h within the undulations 38 and 58 substantially increases the force that would be required to expel the rigid optical component 50 from the housing bore 40 relative to a version in which, all other aspects being equal, the undulations 38 and 58 are absent.

Referring again to FIG. 1, as previously stated, the illustrative light-transmission assembly 10 with hermetic optical connection 20 further includes a second flexible light conduit 200. The second light conduit 200 is situated in the second region R_{2HP} of relatively high fluid pressure and includes opposed first and second light-conduit ends 210 and 220 exhibiting, respectively, first and second light-conduit faces 212 and 222 through which light can alternatively enter and exit the second flexible light conduit 200. A second-conduit core 230 having a second-core refractive index n_{core2} extends between the first and second light-conduit ends 210 and 220. The second-conduit core 230 is encased in a second-conduit cladding 240 having a second-cladding refractive index n_{clad2} lower in magnitude than the second-core refractive index n_{core2} such that light entering either of the first and second light-conduit faces 212 and 222 is internally reflected through the light conduit 200 for emission through the opposite one of the first and second light-conduit faces 212 and 222. The second-conduit cladding 240 includes an outer surface 242 that, in the case of the illustrative version of FIG. 1, constitutes a light-conduit outer surface 225 extending between the first and second light-conduit ends 210 and 220 of the second light conduit 200. In alternative versions, the first-conduit cladding 240 is itself jacketed in a flexible protective casing (not shown) such that the light-conduit outer surface 225 and the outer surface 242 of the second-conduit cladding 240 are mutually distinct.

In a manner analogous to that in which the first flexible light conduit 100 is optically coupled with the rigid optical component 50, the second flexible light conduit 200 extends through the second housing end 34 such that (i) the first light-conduit end 210 is within the housing bore 40, (ii) the first light-conduit face 212 is optically aligned with the second optical-component face 54f, and (iii) the second light-conduit end 220 is external to the housing 30. The optically aligned second optical-component face 54f and first light-conduit end 210 are retained within the housing bore 40 in fixed positions relative to one another and to the housing 30. However, for alternative illustrative purposes, unlike the illustrative example of the optically aligned first optical-component face 52f and the first light-conduit end 110 of the first light conduit 100, the second optical-component face 54f is not retained in mutual mechanical contact with the first light-conduit face 212 of the second flexible light conduit 200. In versions in which a space is anticipated between the rigid optical component 50 and either of a first or second flexible light conduit 100 or 200, an optical bonding agent 70 such as an optical epoxy may be used in order to minimize light-transmission interruption if bonding agent 70 sets between the rigid optical component 50 and either of a first or second flexible light conduit 100 or 200.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A hermetic optical connection comprising:
a housing having opposed first and second housing ends and a housing side wall extending between the first and second housing ends and including an exterior surface and an interior surface defining a housing bore that extends between and through the first and second housing ends;
a light-transmissive, rigid optical component having opposed first and second optical-component faces and an optical-component side wall extending between the optical-component faces, wherein (i) at least a portion of the optical-component side wall is situated within the housing bore and (ii) the housing and rigid optical component are configured such that a void is defined between the optical-component side wall and the interior surface of the housing; and
a bonding agent that (a) is disposed within the peripheral void in order to bond the rigid optical component to the interior surface of the housing side wall and (b) sufficiently surrounds the optical-component side wall to prevent the flow of fluid through the housing.

2. The hermetic optical connection of claim 1 wherein the rigid optical component includes a core exhibiting a first refractive index and a cladding disposed about the core and exhibiting a second refractive index, lower in magnitude than the first refractive index, such that light entering one of the first and second faces can propagate by internal reflection between the first and second faces and exit the face opposite the face through which the light entered.

3. The hermetic optical connection of claim 2 wherein at least one of (i) the interior surface of the housing and (ii) the optical-component side wall includes at least one undulation in which the bonding agent is disposed.

4. The hermetic optical connection of claim 1 wherein at least one of (i) the interior surface of the housing and (ii) the optical-component side wall includes at least one undulation in which the bonding agent is disposed.

5. The hermetic optical connection of claim 4 wherein the rigid optical component is situated within the housing bore such that at least one of (i) the first optical-component face is situated within the housing bore and recessed relative to the first housing end, and (ii) the second optical-component face is situated within the housing bore and recessed relative to the second housing end.

6. The hermetic optical connection of claim 5 wherein the bonding agent comprises at least one of (i) frit, (ii) epoxy, (iii) fused glass and (iv) polymeric material.

7. The hermetic optical connection of claim 1 wherein the bonding agent comprises at least one of (i) frit, (ii) epoxy, (iii) fused glass and (iv) polymeric material.

8. A light-transmission assembly for use through a bulkhead separating regions of relatively low and high fluid pressure, the optical assembly comprising:
a housing configured for sealable disposition within a bulkhead bore extending between the regions of relatively low and high fluid pressure, the housing having opposed first and second housing ends and a housing side wall extending between the first and second housing ends and including an exterior surface and an interior surface defining a housing bore that extends between and through the first and second housing ends;
a light-transmissive, rigid optical component having opposed first and second optical-component faces and an optical-component side wall extending lengthwise between the optical-component faces, wherein (i) at least a portion of the length of the optical-component is situated within the housing bore, (ii) the housing bore and rigid optical component are configured, and relatively situated, such that a peripheral void surrounds at least a portion of the length of the optical-component side wall, and (iii) the optical-component side wall and the interior surface of the housing are mutually bonded by a bonding agent that (a) is disposed within the peripheral void and (b) sufficiently surrounds the optical-component side wall to prevent the flow of fluid through the housing; and
a first flexible light conduit including opposed first and second light-conduit faces through which light can enter and exit the first flexible light conduit, and a light-conduit outer surface extending between the first and second light-conduit faces;
wherein the first light-conduit face of the first flexible light conduit is retained in optical alignment with the first optical-component face.

9. The light-transmission assembly of claim 8 wherein at least one of
(i) the rigid optical component includes a core exhibiting a first refractive index and a cladding disposed about the core and exhibiting a second refractive index, lower in magnitude than the first refractive index, such that light entering one of the first and second faces can propagate by internal reflection between the first and second faces; and
(ii) the first flexible light conduit has a first-conduit core having a first core refractive index and a first-conduit cladding encasing the first-conduit core and having a first-cladding refractive index, lower in magnitude than the first-core refractive index, such that light entering one of the first and second light-conduit faces is internally reflected through the first flexible light conduit.

10. The light-transmission assembly of claim 9 wherein at least one of (i) the interior surface of the housing and (ii) the optical-component side wall includes at least one undulation within which the bonding agent is disposed.

11. The light-transmission assembly of claim 8 wherein at least one of (i) the interior surface of the housing and (ii) the optical-component side wall includes at least one undulation within which the bonding agent is disposed.

12. The light-transmission assembly of claim 8 further comprising a second flexible light conduit including opposed first and second light-conduit faces through which light can enter and exit the second flexible light conduit, and a light-conduit outer surface extending between the first and second light-conduit ends; wherein the first light-conduit face of the second flexible light conduit is retained in optical alignment with the second optical-component face.

13. The light-transmission assembly of claim 12 wherein at least one of
(i) the rigid optical component includes a core exhibiting a first refractive index and a cladding disposed about the core and exhibiting a second refractive index, lower in magnitude than the first refractive index, such that light entering one of the first and second faces can propagate by internal reflection between the first and second faces;
(ii) the first flexible light conduit has a first-conduit core having a first core refractive index and a first-conduit cladding encasing the first-conduit core and having a first-cladding refractive index, lower in magnitude than the first-core refractive index, such that light entering one of the first and second light-conduit faces of the first flexible light conduit is internally reflected through the first flexible light conduit; and
(iii) the second flexible light conduit has a second-conduit core having a second core refractive index and a second-conduit cladding encasing the second-conduit core and having a second-cladding refractive index, lower in magnitude than the second-core refractive index, such that light entering one of the first and second light-conduit faces of the second flexible light conduit is internally reflected through the second flexible light conduit.

14. The light-transmission assembly of claim 13 wherein at least one of
(i) the first optical-component face is recessed relative to the first housing end and the first flexible light conduit extends through the first housing end such that the first and second light-conduit ends of the first flexible light conduit are, respectively, within the housing bore and external to the housing; and
(ii) the second optical-component face is recessed relative to the second housing end and the second flexible light conduit extends through the second housing end such that the first and second light-conduit ends of the second flexible light conduit are, respectively, within the housing bore and external to the housing.

15. The light-transmission assembly of claim 12 wherein at least one of
(i) the first optical-component face is recessed relative to the first housing end and the first flexible light conduit extends through the first housing end such that the first and second light-conduit ends of the first flexible light conduit are, respectively, within the housing bore and external to the housing; and
(ii) the second optical-component face is recessed relative to the second housing end and the second flexible light conduit extends through the second housing end such that the first and second light-conduit ends of the second flexible light conduit are, respectively, within the housing bore and external to the housing.

16. The light-transmission assembly of claim 8 wherein the first optical-component face is recessed relative to the first housing end and the first flexible light conduit extends through the first housing end such that the first and second light-conduit ends of the first flexible light conduit are, respectively, within the housing bore and external to the housing.

17. The light-transmission assembly of claim 16 wherein the optically aligned first optical-component face and first light-conduit face are retained in mutual mechanical contact within the housing bore.

18. The light-transmission assembly of claim 16 wherein at least one of (i) the interior surface of the housing and (ii) the optical-component side wall includes at least one undulation within which the bonding agent is disposed.
